(19) United States
(12) Patent Application Publication
(10) Pub. No.: US 2026/0031073 A1
(43) Pub. Date: Jan. 29, 2026

(54) ELECTRONIC MUSIC GENERATING DEVICE INCLUDING KEY ASSEMBLIES AND RELATED METHODS

(71) Applicant: DOG PAW INC., Berkeley, CA (US)

(72) Inventors: Trevor Joseph HOFFMAN, Allston, MA (US); Alois CERBU, Oakland, CA (US); William David BARTKE-CROUGHAN, Oakland, CA (US)

(21) Appl. No.: 19/279,975

(22) Filed: Jul. 24, 2025

Related U.S. Application Data
(60) Provisional application No. 63/675,683, filed on Jul. 25, 2024.

(51) Int. Cl. G10H 1/34; G10H 1/00

(52) U.S. Cl. CPC G10H 1/344; G10H 1/0008; G10H 2220/061; G10H 2220/251; G10H 2220/295; G10H 2220/311

(57) ABSTRACT

An electronic music generating device may include key assemblies. Each key assembly may include a base, an arm having a proximal end pivotably coupled to the base, and a cap carried by a distal end of the arm. Each key assembly may include a foot coupled to a distal end of the arm and extending down to the base in spaced relation from the proximal end of the arm, and a stop member carried by the base and to engage the foot upon movement of the arm to a depressed position. Each key assembly may also include a biasing member coupled to the arm and to engage the base for biasing the arm to an unpressed position, and a magnetic position sensor associated with the foot. A controller may cooperate with each magnetic position sensor to generate a sound based upon a sensed position of each foot.

### RELATED APPLICATIONS

The present application claims the priority benefit of provisional application Ser. No. 63/675,683 filed on Jul. 25, 2024, the entire contents of which are herein incorporated by reference.

### TECHNICAL FIELD

The present embodiments are directed to the field of music, and, more particularly, to electronic music generating devices.

### BACKGROUND

In the past couple of decades, grid controllers like the Ableton Push and Novation Launchpad have become increasingly popular as tools for producing electronic music. Recently, they have developed features to allow producers to use the grid of buttons to directly play musical notes. A two-dimensional grid-based note layout offers numerous conceptual and ergonomic benefits over a traditional linear arrangement of pitches, as on a piano keyboard. However, the hardware design of the Push, Launchpad, and similar instruments are rooted as digital controllers and may not provide playing experiences when playing notes to rival the piano, or similar instruments rooted in acoustic instrument design.

### SUMMARY

An electronic music generating device may include a plurality of key assemblies. Each key assembly may include a key base and an arm having a proximal end pivotably coupled to the key base. Each key assembly may also include a cap carried by a distal end of the arm for engaging a user's finger to move the arm to a depressed position and a foot coupled to a distal end of the arm and extending down to the key base in spaced relation from the proximal end of the arm. Each key assembly may further include a stop member carried by the key base and configured to engage the foot upon movement of the arm to a depressed position, a biasing member coupled to the arm and configured to engage the key base for biasing the arm to an unpressed position, and a magnetic position sensor associated with the foot. The electronic music generating device may also include a controller cooperating with each magnetic position sensor and configured to generate a sound based upon a sensed position of each foot.

The magnetic position sensor may be configured to sense relative movement of the foot in lateral and vertical directions, for example. Each key assembly may include at least one magnet carried by the foot.

The at least one magnet may include a plurality of magnets arranged in alternating polarity, for example. The at least one magnet may include magnetic tape.

The stop member may include a resilient stop member. The biasing member may be integrally formed with the arm, for example.

The plurality of keys may be arranged in at least one of rows and columns, for example. The electronic music generating device may include a light source coupled to the controller adjacent the plurality of key assemblies.

The controller may be configured to selectively operate the light source based upon the position of at least one foot. The light source may include a plurality of light emitting diodes each associated with a corresponding one of the plurality of key assemblies, for example.

The electronic music generating device may include a haptic actuator coupled to the controller to provide haptic feedback based upon the sensed position of each foot, for example. The cap may have a curved shape. The cap may have at least one internal partition to define a plurality of individually settable light elements, for example.

A method aspect is directed to a method of making a music generating device. The method may include assembling each of a plurality of key assemblies. Assembling each of the key assemblies may include pivotably coupling a proximal end of an arm to a key base, positioning a cap carried by a distal end of the arm for engaging a user's finger to move the arm to a depressed position, and coupling a foot to a distal end of the arm and extending down to the key base in spaced relation from the proximal end of the arm. Assembling each of the key assemblies may also include positioning a stop member carried by the key base to engage the foot upon movement of the arm to a depressed position, coupling a biasing member to the arm to engage the key base for biasing the arm to an unpressed position, and positioning a magnetic position sensor to be associated with the foot. The method may also include coupling a controller to cooperate with each magnetic position sensor and configured to generate a sound based upon a sensed position of each foot.

Positioning the magnetic position sensor may include positioning a magnetic position sensor configured to sense relative movement of the foot in lateral and vertical directions, for example. Assembling each key assembly may include positioning at least one magnet carried by the foot.

The biasing member may be integrally formed with the arm, for example. The method may also include arranging the plurality of keys in at least one of rows and columns. The method may include coupling a light source to the controller adjacent the plurality of key assemblies, and wherein the controller may be configured to selectively operate the light source based upon the position of at least one foot, for example. The method may also include coupling a haptic actuator to the controller to provide haptic feedback based upon the sensed position of each foot.

### BRIEF DESCRIPTION OF THE DRAWINGS

FIG. 1 is a photo of an exemplary electronic music generating device according to an embodiment.

FIG. 2 is a schematic block diagram of the electronic music generating device of FIG. 1.

FIG. 3 is a schematic side view of key assemblies according to an embodiment of the electronic music generating device.

FIG. 4 is a schematic perspective view of the key assemblies of FIG. 3.

FIG. 5 is a schematic side view of key assemblies according to an embodiment of the electronic music generating device.

FIG. 6 is the schematic side of the key assemblies of FIG. 5 with a portion of the bases removed.

FIG. 7 is the schematic side of the key assemblies of FIG. 6 with feet and key caps removed.

FIG. 8 is a schematic block diagram illustrating an exemplary key assembly layout in accordance with another embodiment.

FIG. 9 is a schematic side view of key assemblies according to another embodiment.

FIG. 10 is a schematic side view of a portion of an unpressed key assembly in accordance with another embodiment.

FIG. 11 is a schematic side view of the portion of the key assembly of FIG. 10 depressed.

FIG. 12 is a schematic diagram of a light source arrangement in accordance with an embodiment.

FIG. 13 is a schematic diagram of a light source arrangement in accordance with another embodiment.

FIG. 14 is a schematic side view of a key assembly and associated circuitry in accordance with an embodiment.

FIG. 15 is a schematic block diagram of a key cap in accordance with another embodiment.

FIG. 16 is a schematic side view of a key assembly in accordance with another embodiment.

FIG. 17 is a schematic side view of a key assembly in accordance with another embodiment.

FIG. 18 is a schematic side view of a key assembly in accordance with another embodiment.

FIG. 19 is a schematic side view of a portion of a key assembly in accordance with another embodiment.

FIG. 20 is a schematic block diagram of a portion of a key assembly in accordance with another embodiment.

FIG. 21 is a schematic side view of portions of key assemblies in accordance with another embodiment.

FIG. 22 is a schematic cross-sectional view of a portion of a key assembly of FIG. 21.

FIG. 23 is a schematic perspective view of a key assembly in accordance with another embodiment.

FIG. 24 is another schematic perspective view of the key assembly in FIG. 23.

FIG. 25 is an exploded view of the key assembly of FIG. 23.

FIG. 26 is an exploded view of the key assembly of FIG. 24.

FIG. 27 is a perspective view of a key assembly in accordance with another embodiment.

FIGS. 28 and 29 are exemplary key mapping for use with the electronic music generating system according to an embodiment.

FIG. 30 is a schematic block diagram illustrating a steeped arrangement of key assemblies in accordance with an embodiment.

FIG. 31 is a perspective view of an electronic music generating device according to another embodiment.

FIG. 32 is a schematic perspective view of a row or column of a portion of key assemblies of the electronic music generating device of FIG. 31.

FIG. 33 is a schematic side view of a portion of the key assemblies of FIG. 32.

FIG. 34 is another schematic side view of a portion of the key assemblies of FIG. 32 including a frame.

FIG. 35 is a schematic block diagram of a portion of the electronic music playing device according to the embodiment of FIG. 31.

FIG. 36 is a schematic side view of a portion of a key assembly in accordance with another embodiment.

FIG. 37 is a schematic perspective view of the portion of the key assembly of FIG. 36.

FIG. 38 is a schematic perspective view of a cap of an electronic music generating device in accordance with an embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and numbers in increments of 100 are used to indicate similar elements in alternative embodiments.

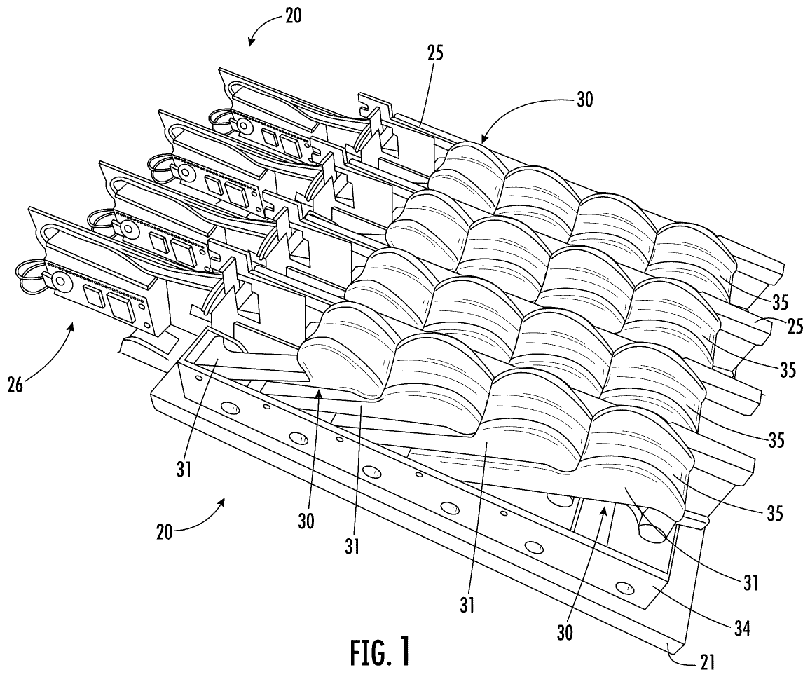

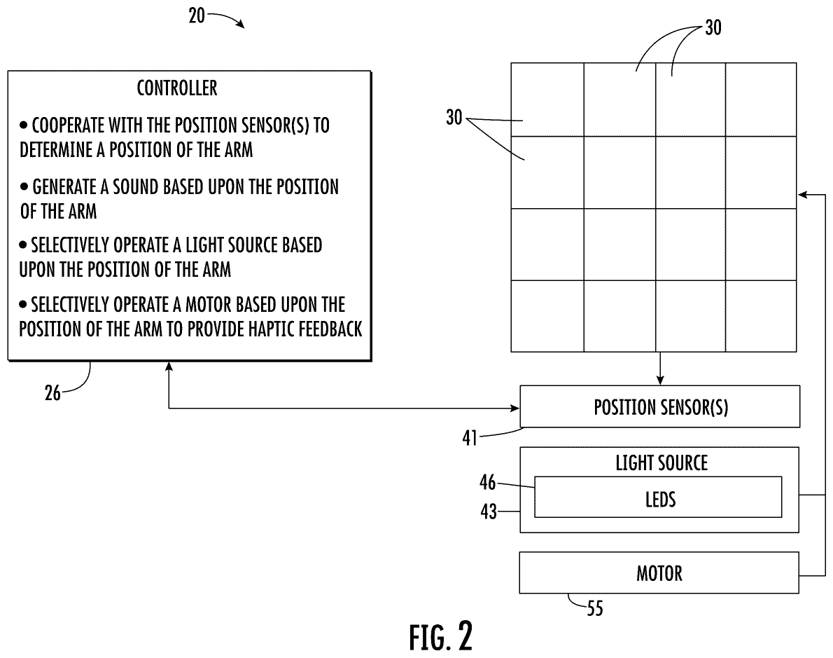

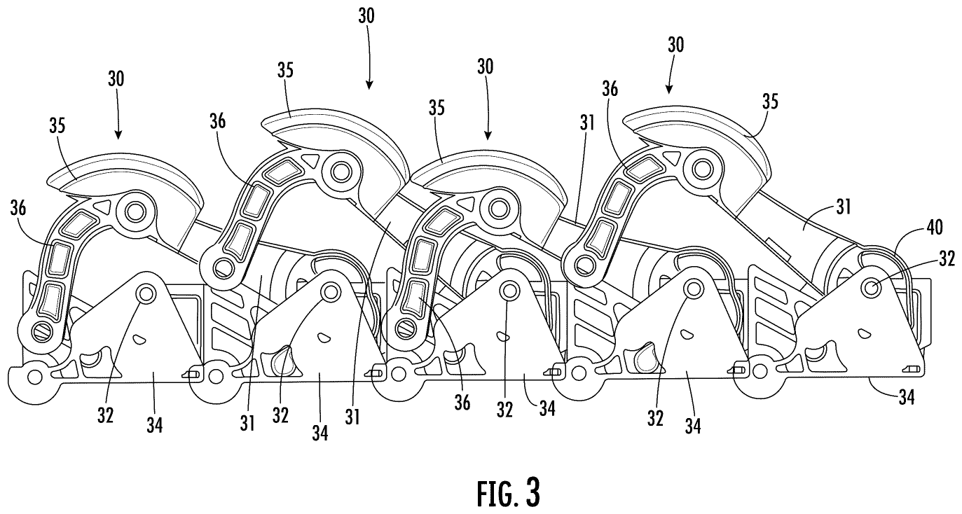

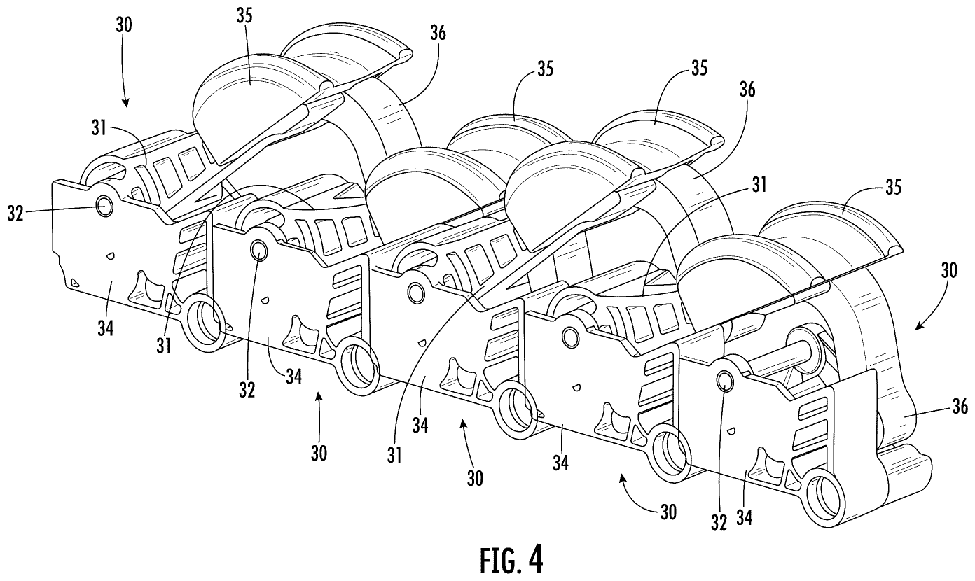

Referring initially to FIGS. 1-7 an electronic music generating device 20 includes a grid or array of rectangular keys or key assemblies 30. Each key assembly 30, which may be referred to as a key, operates by moving up and down a fixed amount and provides a tactile feel, for example, to a user, like a piano key.

Each key assembly 30 includes an arm 31 coupled to a base 34 at a proximal end, and that rotates around a pivot 32, similar to a piano key. The base 34 for a row or column of key assemblies 30 may be monolithically formed, for example, molded as a single unit. Multiple bases 34 may be coupled to or carried by a rigid baseplate 21.

Each arm 31 may extend over multiple key assembly “lengths” as will be appreciated by those skilled in the art. More particularly, instead of extending over the following key's base 34, a given arm 31 may extend over a larger number of keys 30. The arms 31 may be interleaved in this way to accommodate a combination of achieving longer arms and smaller key sizes, for example.

A foot 36 is coupled to a distal end of the arm 31. A key cap 35 may be carried by the arm 31 for engaging a user's finger to move the arm to a depressed position. As it moves and rotates, the curve of the key cap 35 enables the player's finger to maintain a consistent angle of pressure on the key cap, making the movement feel more linear, as will be described in further detail below. Each key cap 35 may include one or more indentations or protrusions, similar to F and J keys on computer keyboard, to allow the player to orient their hands without looking at the instrument or electronic musical device 20.

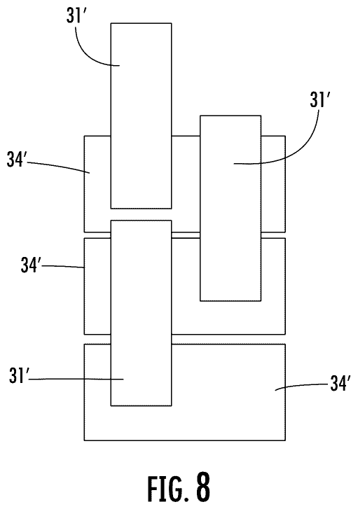

Referring briefly to FIG. 8, in another embodiment, each base 34′ is aligned in sequence, but the arms 31′ may be offset horizontally from each other so that the foot may be inline with the corresponding arm. This may permit relatively easier manufacturing, for example, as a monolithic unit.

Referring again to FIGS. 1-7, each arm 31 may be dimensioned specifically so that it can move through its full range of motion without interacting, interfering with, or otherwise crossing the range of motion of adjacent arms. The overlapping pattern allows the end of the arms 31 to be further from the pivot 32, thus more closely approximating linear travel at the ends. Each arm 31 engages the flexible pivot 32 at the bottom of its motion, which enables the arm to continue to move downward slightly by squishing the pivot for aftertouch. In some embodiments, the pivot may be rigid except for a relatively small amount of movement related to the vibrato. As will be appreciated by those skilled in the art, aftertouch may refer to a measured pressure on each individual key after the key has reached the bottom of its “standard” vertical motion used to trigger a note. In some embodiments, aftertouch may be synonymous with polytouch, and/or represent a global pressure across all keys on a keyboard or individually for each key.

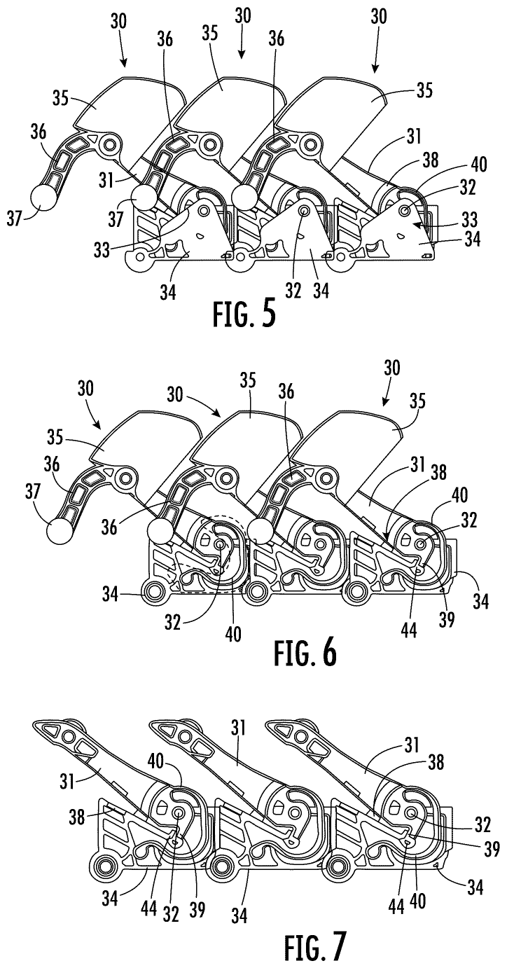

Each arm 31 also rotates around the pivot 32 due to grooves 33 (FIG. 5), for example, compliant grooves, cut around the pivot in the base 34, enabling the arm to move horizontally or laterally. This motion gives the user or player access to vibrato or similar expressive control. Because the arms 31 are shorter than piano keys, they may not achieve the same level of linearity in their motion. The feeling of the key motion being curved is mitigated by the shape of the key cap 35.

As will be appreciated by those skilled in the art, the compliant grooves 38 permit the pivot 32 to rotate slightly and enable lateral motion of the key assembly 30. During testing of the key assemblies 30 without the compliant grooves 38, the natural compliance of the arm 31 itself may be sufficient to permit some lateral motion of the keys (i.e. side-to-side and not up-down).

A biasing member 40 is coupled to the arm 31 and engages the base 34 for biasing the arm to an unpressed position. More particularly, the biasing member 40, which may be integrally molded with the arm 31 or part of the arm, is between the proximal end of the arm and the base 34. Upward force is provided by the biasing member 40, which is in the form of a spring, and, more particularly, a compliant spring or extension of the arm 31. The biasing member 40 sits in pockets within the base 34. Preload is applied to the biasing member 40 or spring on installation, and the upward motion is limited by a travel stop 39 of the arm 31, which, at its limit, engages a corresponding travel stop 44 of the base 34.

A magnet 37 is carried by a distal end of the arm 31 (FIGS. 5-6). More particularly, the magnet 37 is carried by the foot 36. The magnet 37 may be used for modifying a resistance force of each key 30. There may be more than one magnet 37.

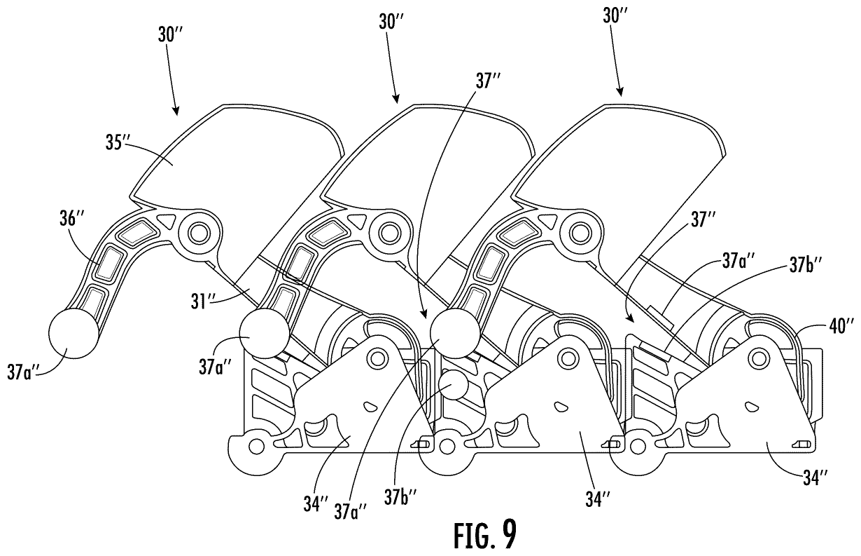

For example, for modifying resistance, referring to FIG. 9, rightmost key 30″ shows two magnets 37a″, 37b″ directly opposite each other to either reduce or increase the force, with the magnet's nonlinear force having an increased impact near the bottom of the key's motion. The placement of the magnets 37a″, 37b″ in the middle key assembly 30″ is such that one magnet 37b″ is attached to the base 34″ that would interact with the magnet 37a″ used for position sensing, as will be described in further detail below.

In this arrangement, the magnets 37a″, 37b″ could either increase or decrease the resistance, but additionally by placing the magnet at a height in the middle of the key's travel, it would switch the direction of its force as the key arm's magnet passes it. Such a placement could, for instance, increase the upward force near the bottom of the key's travel until the user passes a threshold, at which point the magnet would actually press the key 30″ down, assisting the user in holding the key fully pressed. The arms 31″, key cap 35″, foot 36″, and biasing member 40″ are similar to those described above.

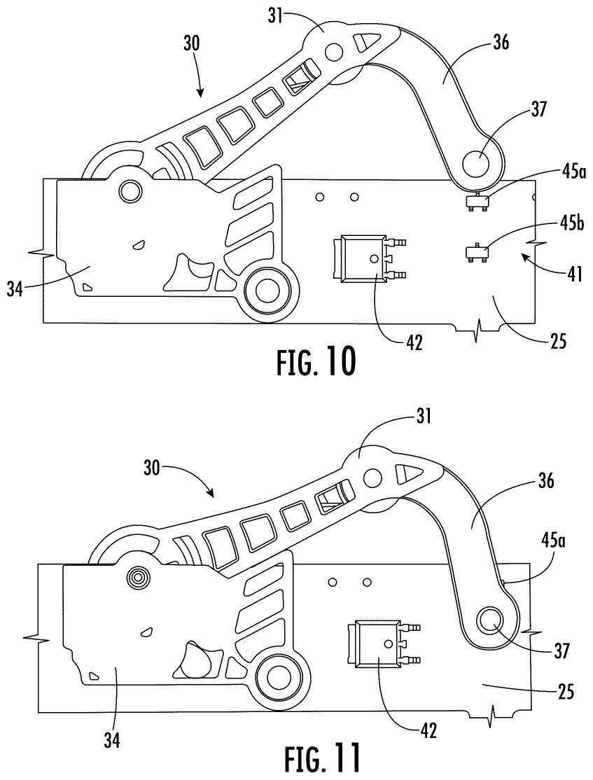

Referring again to FIGS. 1-7 and additionally to FIGS. 10 and 11, a position sensor 41 is carried by a circuit board or frame 25 adjacent to the magnet 37. The circuit board 25, which may be a frame rather than a circuit board, runs alongside each key assembly 30. Circuitry 42, which may be part of a controller 26, may provide motor control. Other circuitry, which may be part of the controller 26, may be coupled to the position sensor 41 of each of the key assemblies 30 to determine a position of the arm 31. The controller 26, based upon the sensed position of the arms 31, generates a sound. The position sensor 41 may include, for example, first and second Hall effect sensors 45a, 45b. The Hall sensors 45a, 45b may be aligned such that the magnet 37 carried by the foot 36 of a given the key assembly 30 moves roughly between the Hall sensor locations as the key is pressed. By including two Hall sensors 45a, 45b, both the horizontal and vertical position of the magnet 37 may be measured. As will be appreciated by those skilled in the art, this arrangement may include increased position measurement rate with relatively low power consumption and relatively little to no friction between the sensors 45a, 45b and the moving parts of the key assembly 30. Any number of position sensing methods or combinations of methods may be used to accomplish a similar measurement of the key position. Other and/or additional techniques for position sensing may be used, for example, time-of-flight infrared (IR) sensors between the arm 31 and stationary base 34, a linear potentiometer attached to the arm and the base, a rotational potentiometer attached to the arm and the base at the pivot, and/or light sensors that become more occluded as the arm rotates forward.

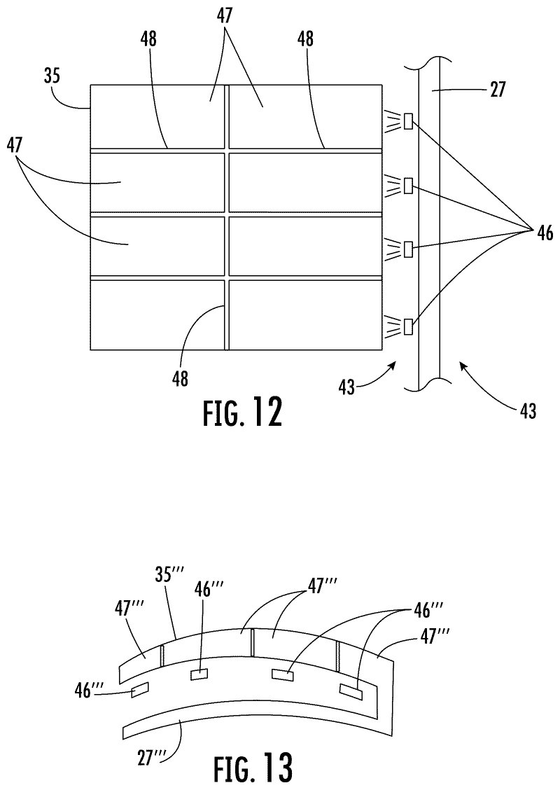

Referring now additionally to FIG. 12, a light source 43 may be coupled adjacent the key assemblies 30 and coupled to the controller 26 (FIG. 1). The controller 26 may be configured to selectively operate the light source 43 based upon the position of the arm 31. The light source 43 may include light emitting diodes (LEDs) 46. Each LED 46 may be associated with a corresponding one of the plurality of key assemblies. Multiple LEDs 46 may be associated with a given key assembly 30, as will be described in further detail below.

Based upon the light source 43, and, more particularly, LEDs 46, the user may receive visual feedback. The visual feedback may be provided by the light source 43, and more particularly, the LEDs 46. The LEDs 46 may include red-green-blue (RGB) LEDs. The LEDs 46 may be carried by a printed circuit board (PCB) 27 adjacent to the key cap 35. The LEDs 46 are coupled to the controller 26 and may be individually addressable. During operation, the controller 26 selectively operates the LEDs 46 so that the user receives visual feedback via the individually addressable LEDs.

The key cap 35 may include transparent zones 47 partitioned by opaque partitions 48 or barriers. In this way, multiple LEDs 46 on each key 30 can be used to indicate persistent color locators or for rapidly updating information about each key simultaneously. The LEDs 46 may be placed inline with the Hall sensors 45a, 45b to illuminate into the sides of the key cap 35, or under each key cap to illuminate from below. In some embodiments, the transparent zones 47 may be translucent. The amount of transparency, and other properties of the material, may affect how uniformly the light shows up across the surface of the transparent zone 47.

Referring briefly to FIG. 13, in another embodiment, the LEDs 46′″ may be carried by a flexible PCB 27′″. The use of the flexible PCB 27′″ may permit the LEDs 46′″ to be more accurately placed about the transparent zones 47′″ and the opaque partitions 48′″ for improved visual feedback.

The assembly of key caps 35 as described herein with the transparent zones 47 and opaque partitions 48 can be achieved through multi-material 3d-printing with a clear and opaque material, as will be appreciated by those skilled in the art. Alternatively, the key caps 35 may be formed by otherwise manufacturing the transparent zones 47 and opaque partitions 48 by overmolding or double-shot molding, or in multiple processes, then inserting the opaque partitions into the hollow transparent zones. In an embodiment, as will be described in further detail below, the transparent zones 47 may also be a function of the geometry itself, as it may be positioned relative to the light sources 43 provided with, for example, just the open back of the key cap 35.

Exemplary use cases for the key cap 35 including the transparent zones 47 will now be described. Each key 30 may have an arbitrary number of arbitrarily shaped transparent zones 47 that can be illuminated with the techniques described above, for example. This may be particularly useful for using a consistent color on each key 30 or key cap 35 to orient the user, while letting a fraction of the key change color dynamically to provide a visual indication to the user. For example, the user may be prompted, by way of selective illumination, to play a certain note.

If a user is pressing a key 30 or key cap 35 with their finger, adjacent zones on adjacent keys may be illuminated to provide visual feedback on the pressed key. This may be more effective than providing visual feedback on the pressed key 30 itself, since most of the light may be blocked by the user's finger. The transparent zones 47 may permit, for instance, just the left side of a key 30 to be illuminated to indicate an action or indication about a key to the left. A column of keys may be used as a vertical indicator of some quantity, for example, an audible volume level. By dividing the key 30 into the transparent zones 47, the resolution at which the quantity indicated may be displayed may be increased. For example, the key 30 may be operated as a horizontal slider, which may be common for panning a track to left or right speakers.

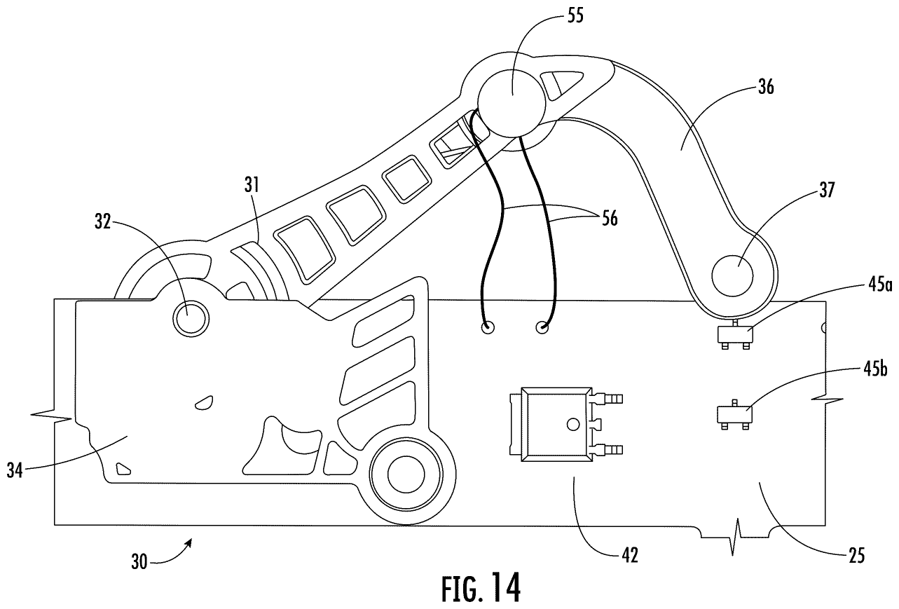

Referring now additionally to FIG. 14, a motor 55 (e.g., a haptic actuator) may be coupled to the controller 26 and carried by an arm 31. A respective motor 55 may be carried by each arm 31. More particularly, the motor 55 may be carried at the distal end of the arm 31 where the foot 36 is coupled to the arm. The motor 55 may be carried by the key cap 35, or carried under the key cap in order to restrict the haptics to only one key.

The controller 26 may be configured to selectively operate the motor 55 based upon the position of the corresponding arm 31 or foot 36 to provide haptic feedback. The controller 26 may include circuitry, for example, driving circuitry carried by a corresponding PCB 25. Electrical connectors 56 may provide an electrical connection between the circuitry and the motor 55.

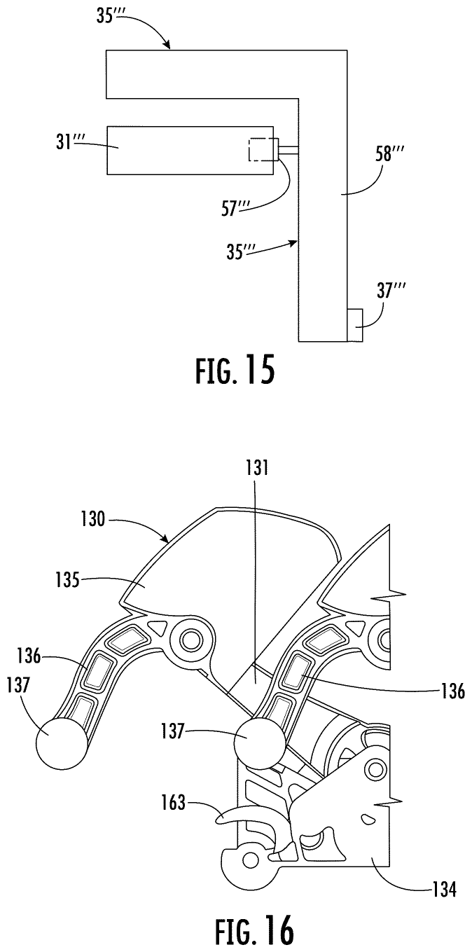

Referring now to FIG. 15, in another embodiment, a rigid hinge 57″″ without grooves may be used with a compliant attachment of the key cap 35″″ to allow for horizontal motion of the key cap relative to the base (not shown) without any horizontal motion of the arm 31″″. This variation may also include an extended lever arm 58″″ of the key cap 35″″ on which to place the magnet 37″″, thus creating a variable motion of the magnet relative to the motion of the key cap 35″″. This may enable more accurate sensing of the horizontal magnet position.

Referring now to FIG. 16, in another embodiment, a variation of a key assembly 130 includes a compliant pad 163 or section of the base 134 where it contacts the foot 136 of an adjacent key assembly, thus creating increased resistance in the aftertouch section of the vertical travel. The arm 131, key cap 135 and magnet 137 are similar to those described above.

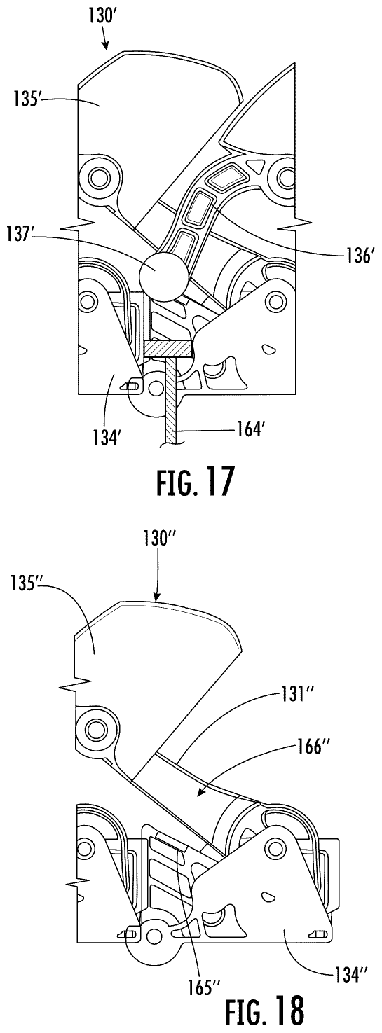

Referring now to FIG. 17, a related variation of a key assembly 130′ includes a mechanism by which each such section of the base 134′ can move vertically, either in concert with the other keys' bases or individually. This could be accomplished by a screw mechanism 164″ under each such section. Thus, a user could adjust the amount of vertical travel or amount of aftertouch available to each key 130′. The arm 131′, the base 134′, key cap 135′, and magnet 137′ are similar to those described above.

Referring now to FIG. 18, yet another variation includes an electromagnet 165″ carried by the base 134″ which interacts with a magnet 166″ on each arm 131″, or vice versa, to provide increased speed modification of the upward force of the key 130″. The key cap 135″ is similar to that described above.

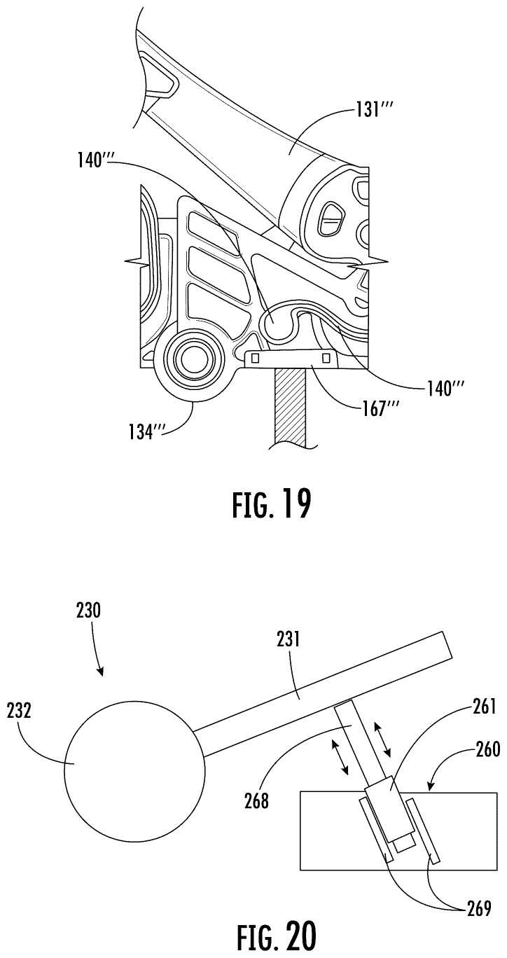

Referring to FIG. 19, a similar modification includes a screw mechanism 167′″ by which a user can adjust the resistance of each key 130′″, either by hand or via an embedded motor, by modifying the exact shape of the coupling section on the base 134′″ with the biasing member 140′″ or compliant spring. The arm 131′″ is similar to that described above.

In an embodiment, an additional sensor may be used, for example, a beam break sensor adjacent the lower hall sensor 45b or any electrical contacts on the foot 36 and base 34 to detect when a key has reached a certain point in its vertical motion. This may be particularly advantageous for more accurately detecting when a key should trigger a note, or generate its corresponding sound, as it reaches a consistent point of its motion. These methods are immune to small differences that may be incurred by nearby magnetic fields.

Another embodiment may include capacitive touch sensors spaced apart, or a grid of mutual capacitive touch sensors carried by each key cap 35 to measure the user's finger position. These capacitive sensors may be used in addition to or an alternative to the horizontal motion of the magnet 37 to enable the user to control the device 20 by pressing each key cap 35 horizontally, or otherwise changing their finger's posture on the key cap. Capacitive pads may be embedded in a flexible PCB to accommodate a curved key cap surface. A variation includes using a flexible PCB or wires to connect a magnetometer or hall sensor to the mobile part of each key, and a passive magnet to the stationary part of the key nearby. This enables each key's motion to be measured magnetically without the possibility of interference from the motion of other keys

Referring briefly to FIG. 20, in another embodiment, a linear variable differential transformer 260 is provided to measure the vertical position of each key 230, and more particularly, the arm 231 as it moves about the pivot 232. More particularly, an inductive or ferromagnetic core 261 is carried by a shaft 268 hingeably coupled to the arm 231. The core 261 moves through coils 269, as the key 230 or arm 231 is depressed.

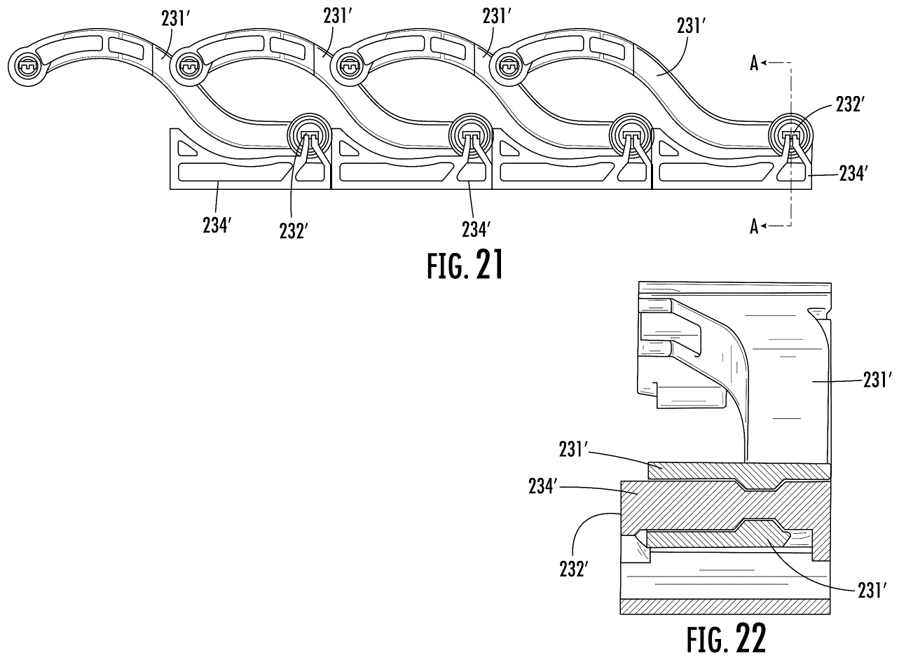

Referring now briefly to FIGS. 21 and 22, in another embodiment, a hinge is used that may be printed in place for example, with a 3D printer. More particularly, the arm 231′ has an opening therein adjacent its proximal end, and the base 234′ may define the pinned axis or pivot 232′.

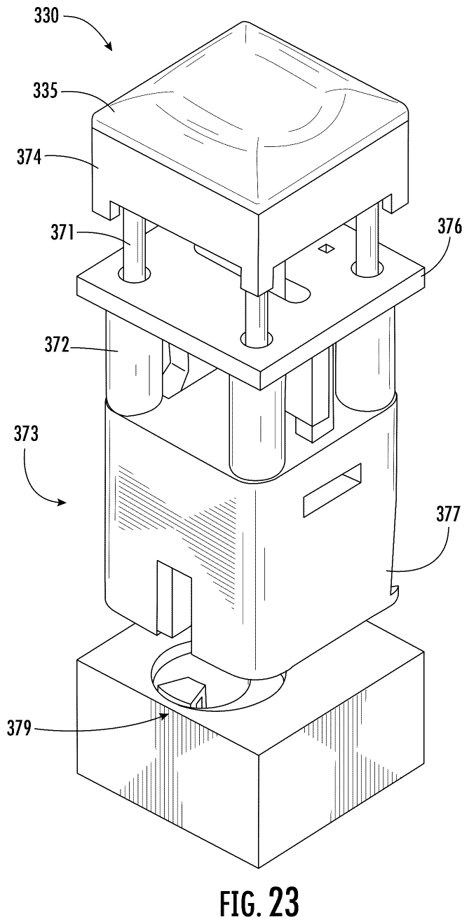

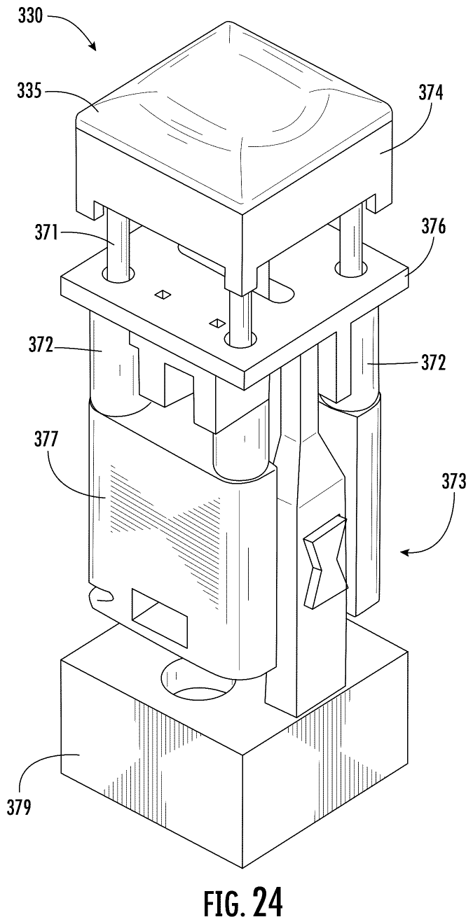

Referring now to FIGS. 23-26, in another embodiment, a key assembly 330 may enable linear motion in a grid. A rectangular key cap 335 is coupled, rigidly, to linear rails 371, which move through associated linear guides 372 on a rigid base 373. Resistance is provided by a metal spring or a compliant mechanism (not shown). More particularly, a key cap 335 is carried by a first body 374. The first body 374 includes a lower protrusion 375 that engages a third body 377, defining a first base portion, and is carried by a second body 376. The first body 374 moves vertically upon pressing by a user's finger on the key cap 335. The third body 377 is fixed and has openings therein in which rail guides 372, for example, metal rail guides, sit.

An attachment body 378 couples the second body 376 defining the first half of the rigid base 373 with a fourth body 379 defining a second half of the rigid base. The attachment body 378 may not be desirable with other coupling arrangements, as will be appreciated by those skilled in the art.

The third body 377 is coupled, for example, rigidly attached, to the metal rails 371. The third body 377 may have an opening therein to receive a motor, magnet, and a biasing member, for example. The metal rails 371 couple the first body 374 and the third body 377. The metal rail guides 372 assist in providing the metal rails 371 to slide with decreased friction past the stationary second body 376. One of the metal rails 371 may act as a spring guide, for example, whereby a compression spring rests around and is pressed outward against the bottom half of the rigid base 379 and the third body 377 to generate upward force on the key 330.

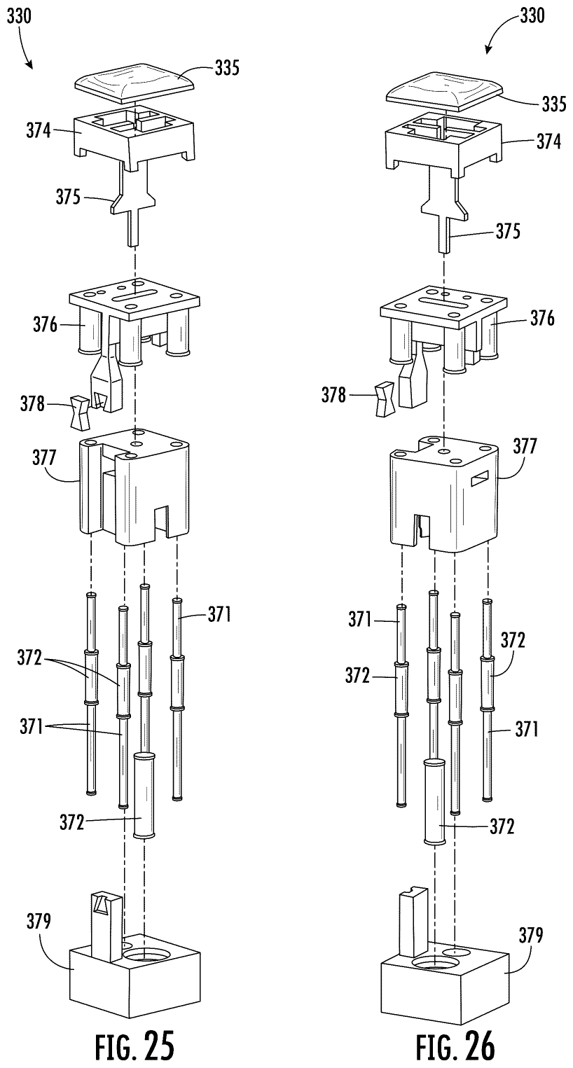

It should be noted that while FIGS. 25 and 26 may illustrate differently, the rails 372 are attached rigidly to the top of the third body 377 and the bottom of the first body 374, and slide freely through the rail guides 372, which themselves are attached to the third body. The bottom half of the rigid base 379 or fourth body has indentation where a magnet can be positioned to generate force on the key 330, and another indentation which lines up with one of the metal rails 372 to attach to the rigid base.

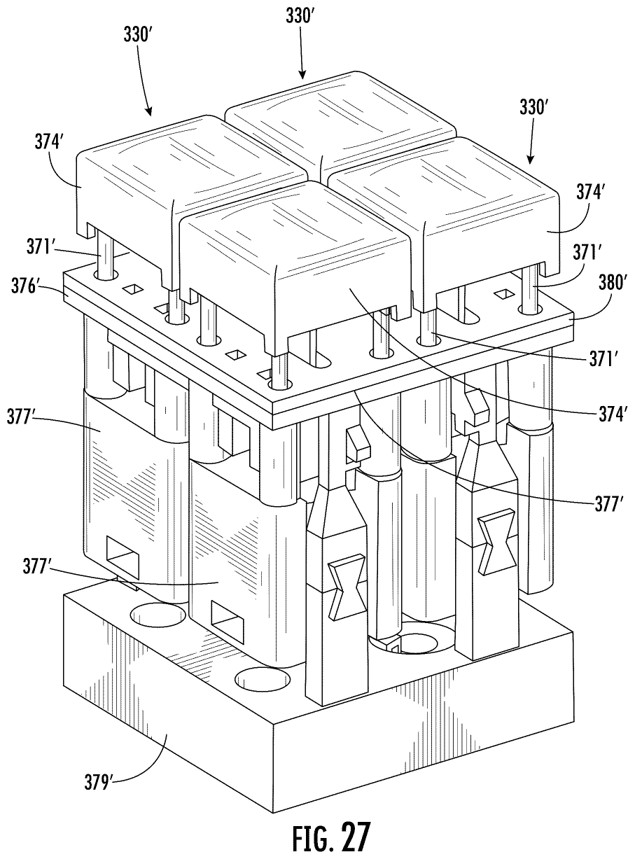

Referring now to FIG. 27, in another embodiment, four key assemblies or keys 330′ sit together. Note that the rigid parts combine to form a single top half 376′ and a single bottom half 379′ across all of the keys, while the other components remain separate so that the keys can move independently. A PCB 380′ may optionally be included to host electronics that can interact with the keys 330′ in ways analogous to those described above. The components are described above, particularly, the bodies 374′, 377′, the rails 371′ and rail guides 372′, are similar to those described above.

As it relates to modularity, the electronic musical generating device 20 may be considered to have a modular design. The modular design may permit relatively easy repair and customization through the replacement of small groups of keys 30. For example, the above-described key assemblies 30 pictured above slide into the rigid baseplate 21. This attachment can be achieved either through a relatively simple press fit, snap fit, or with a locking screw to attach the pieces. Key assemblies 30 may be removed and replaced to enable relatively quick repairs of portions of the entire instrument or electronic music generating device 20.

The key caps 35 may be swappable to enable a user to change the shape of their key caps. For example, a user may combine different shaped key caps across different keys, so long as the shapes do not interfere with each other. The PCB 27 holding the LEDs 46 may be separate from the rest of the circuitry, so that their mounting can be adjusted when the key cap 35 shape changes. The key caps 35 could, for instance, be swapped to a different shape with a different curve radius, or an irregular hexagonal profile.

The arms 31 may also be removed within each key assembly 30 to permit for different spring resistances, lengths of travel, etc. When a key assembly 30 is attached, the corresponding circuitry may be connected to the central computer or the controller 26, via castellated edges mating with a circuit board, similar to a RAM chip slotting into a motherboard, for example.

Additionally, each key assembly 30 may be 3D-printable. This means that components may be customized and shaped by the end user with their own 3D printer. It also means customizability for each user by the manufacturer is relatively simple. For instance, a user could use a web portal to parametrically design their own desired version of the instrument 20 before ordering, and the entire instrument may be made to their specifications.

As it relates to the system architecture of the electronic music generating device 20, microprocessors, such as RP2040s, gather sensor data and drive actuators at each key 30. Data may be sent to a central processor, such as a Raspberry Pi. Collectively, the central processor along with any microprocessors may define the controller 26, as described herein. The central processor or controller 26 generates audio and other outputs in response to the data. Other outputs may include instructions for the peripheral microprocessors on how they should drive their respective actuators, control data for external systems such as lighting, or other user-facing feedback. The central processor or controller 26 may also offload some large parallelizable computations to these microprocessors, such as, for example, generating a wavetable for audio synthesis. The use of a central processor or controller 26 with an operating system may enable users to upload and run their existing audio software such as synthesizers and effects.

In the exemplary implementation that includes microcontrollers and a central processor, communication therebetween can be achieved with high bandwidth and low latency by connecting the microcontrollers to the central computer using a common serial communication protocol, such as, for example, SPI or UART. In the case of UART communication, an intermediary PCIe-UART bridge can be used, which allows the central processor to communicate with the microprocessors through a single PCIe port. In a variation, each microprocessor may be equipped with its own Wi-Fi IC, through which it sends Wi-Fi messages to the central computer instead of communicating through UART. This scheme incurs some latency of communication, but enables peripheral microcontrollers to be separate physically from the central computer, thus enabling multiple users with separate instruments to control the same audio output. These messages can be routed through a local Wi-Fi network, or the central computer can generate its own Wi-Fi network to which the microprocessors connect directly, thus reducing latency and reducing reliance on external network equipment.

With respect to the software architecture associated with the electronic musical generating device 20, software on the central processor may be broken into four separate types of processes. Audio engines generate audio, user interfaces communicate with hardware and software controllers and outputs, and note servers interpret controller data, send control messages to the audio engine, receive feedback from the audio engine, and send user feedback control messages to the UI entities.

There may be one central hub per machine, which tracks the lifecycle of the other entities and informs new entrants of the state of the machine's entities. Each entity may be responsible for keeping the hub updated with its own status, and then sends messages directly to other entities via UDP or TCP, for example, with each entity having a unique port. This modular architecture enables users to easily integrate separate hardware and software controllers to control one or multiple synthesizers. The inter-process OSC communication leverages an industry-standard protocol to enable existing software and hardware to contribute to the corresponding software ecosystem and vice versa. Additionally, any note servers may be easily augmented or replaced with python code by an end user, without impacting the computational efficiency or stability of the audio engine or hardware interactions.

Specific messages from each entity specifying its own capabilities may enable relatively simple expansion of this software ecosystem as end users can add their own controllers and software, with the existing ecosystem able to immediately integrate its functionality. This may be considered analogous to how USB HID components such as mice and keyboards can work nearly instantly on an existing computer. The use of the UDP or TCP protocol to send messages enables easy integration of components within one machine, across a local network, or across the internet. For instance, two players can connect their machines to each other on a Wi-Fi network, or a teacher in another location entirely could interact with a student's instrument over the internet.

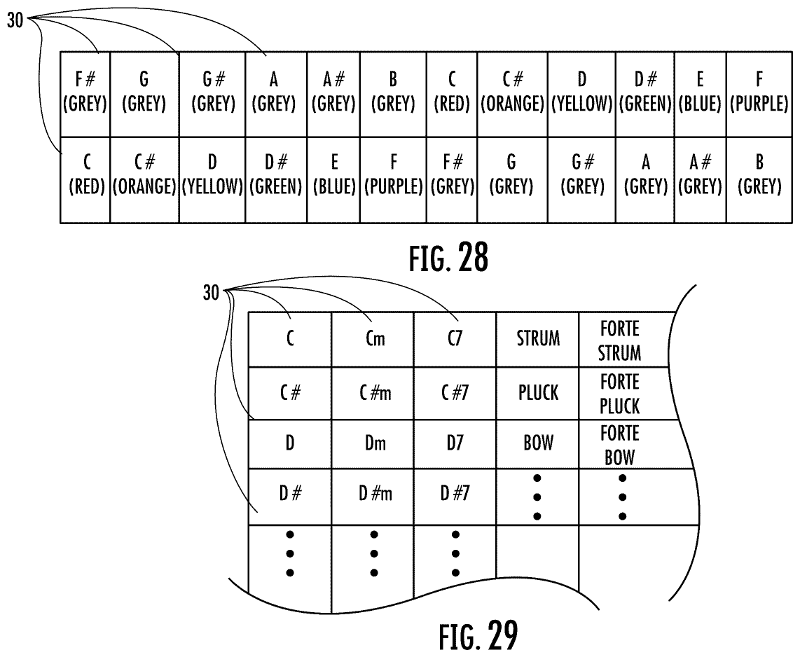

Referring now to the exemplary layouts in FIGS. 28 and 29, as it relates to a user interface, the user can map the grid's buttons arbitrarily. One method of mapping the key assemblies 30 or keys to notes involves laying notes out chromatically from left to right, and in tritones vertically. In this arrangement, octaves repeat every two rows, making visualization of notes and structures across octaves particularly nice. This may also result in the fifth interval corresponding to a diagonal move to the right, which results in common scales such as major, minor, and pentatonic, being laid out in a simple repeating checkerboard pattern. This simplicity may enable easier visualization of many concepts in music theory.

The user can also indicate notes through colors in an arbitrary mapping. One method involves mapping C, C#, D, D#, E, and F to Red, Orange, Yellow, Green, Blue, Purple, respectively. Doing so provides a useful visualization in that every note may be relatively simply oriented by its own color or a directly adjacent color. This may also reduce issues with some traditional instruments wherein some scales are easier to play than others. For instance, piano beginners often play in C-major scale, corresponding to only the white keys, because it is relatively easy to see and describe on the piano.

As it relates to the selecting colors of the LEDs 46, an additional rationale for the choice of colors is that the colors are relatively easy to verbalize, and therefore name each note unambiguously. More complex colors like “teal” might lead to different names by different users, for example. It may also be expected that variations on the colors may be desirable to accommodate color blind players, for example. In the illustrated mapping, no scale's notes are more or less emphasized than any other scale's notes.

Buttons do not have to correspond directly to individual notes. One variation is to map each key on the left side of the instrument to different chords or tones, and the right side of the instrument to different timbres and dynamic patterns. Then a player would hold a given chord with their left hand, and choose the rhythm and dynamics with their right, similar to how a stringed instrument works. More generally, different groups of keys can map to different harmonic, dynamic, and embellishment choices. The position sensing on each key 30 further empowers this scheme. For instance, one key 30 could correspond to strumming notes held with the left hand, where each note is sounded as the key reaches a certain position, thus enabling them to control the speed of the strum like a guitar. A physical modeling software can run an extremely realistic simulation of a drum head that corresponds to the entire playing surface of the instrument. The user can then mute or otherwise interact with the drum's surface by moving the keys as if they were a corresponding portion of the drum head.

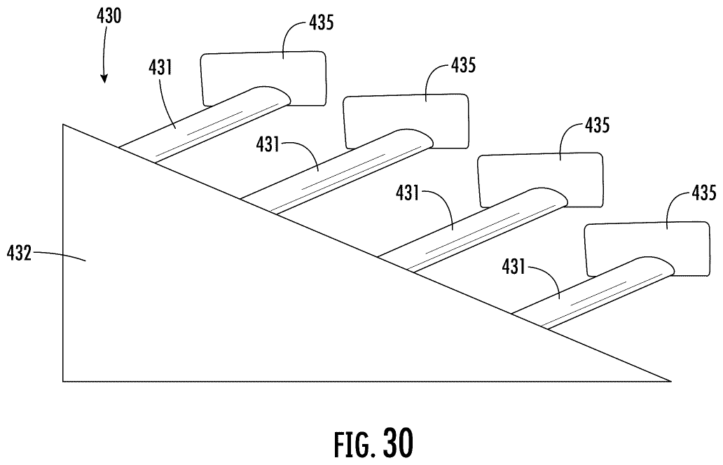

Referring briefly to FIG. 30, the entire user interface of keys 430 including the arms 431 and key caps 435 may be tilted, for example, by way of the base 434, toward the user for better ergonomics, similar to a computer keyboard. The playing surface can also be curved to match more natural movements of the elbows and wrists of the player. The design of a single or group of keys 430 may be separated for use as its own auxiliary controller. In an exemplary implementation, a group of keys 430 may be used as a foot controller similar to an expression pedal but with additional degrees of freedom. Because the key position is read magnetically, the user can interact with the instrument by moving a magnet over it instead of pressing the keys. This gives the same hardware a unique new way of interacting with the player, enabling them to “bow” the instrument. For instance, the right hand of the user could move like a violin bow across many keys, while the left hand may choose notes as described above.

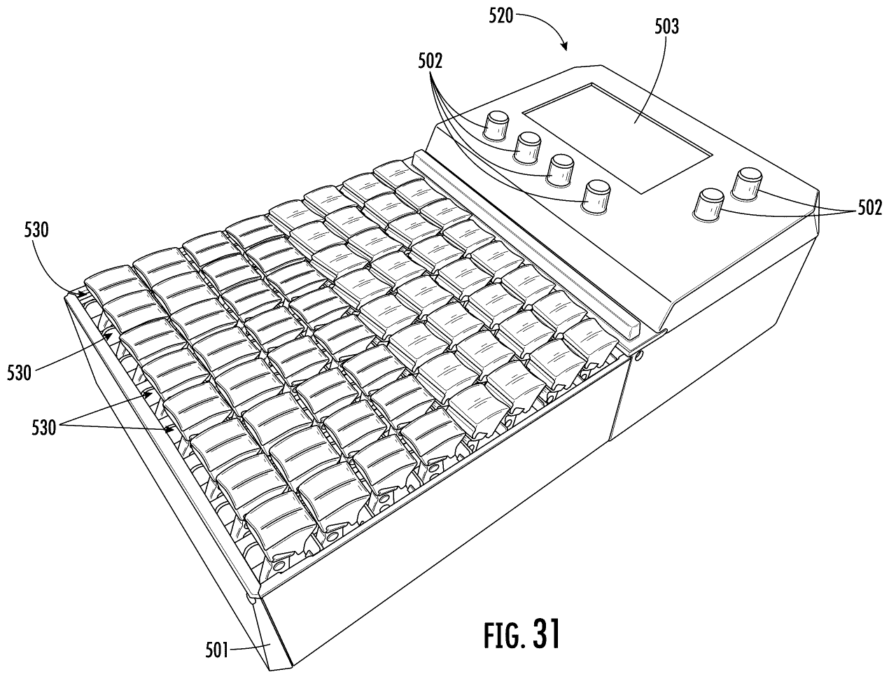

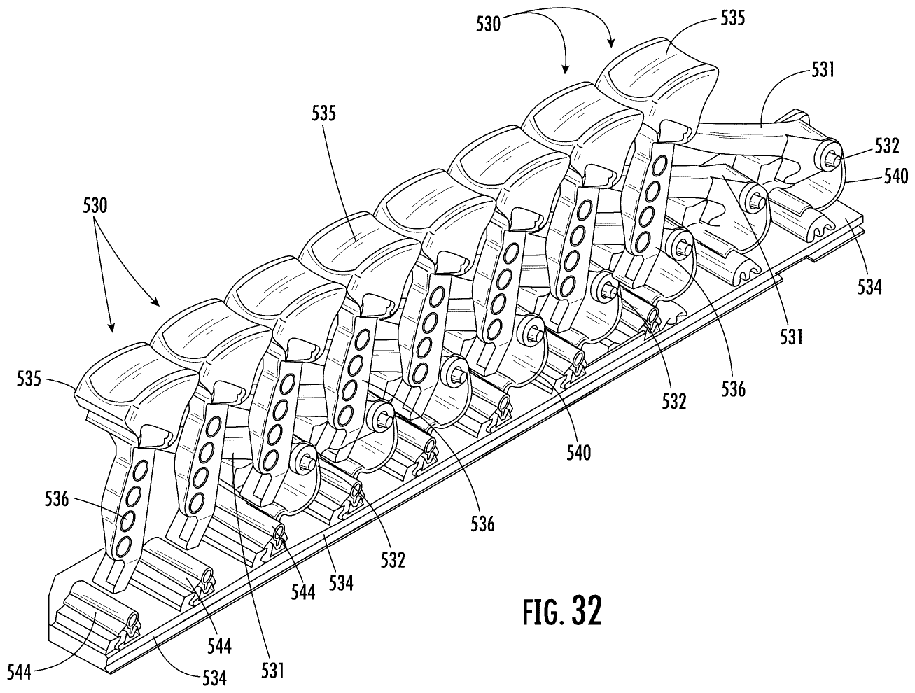

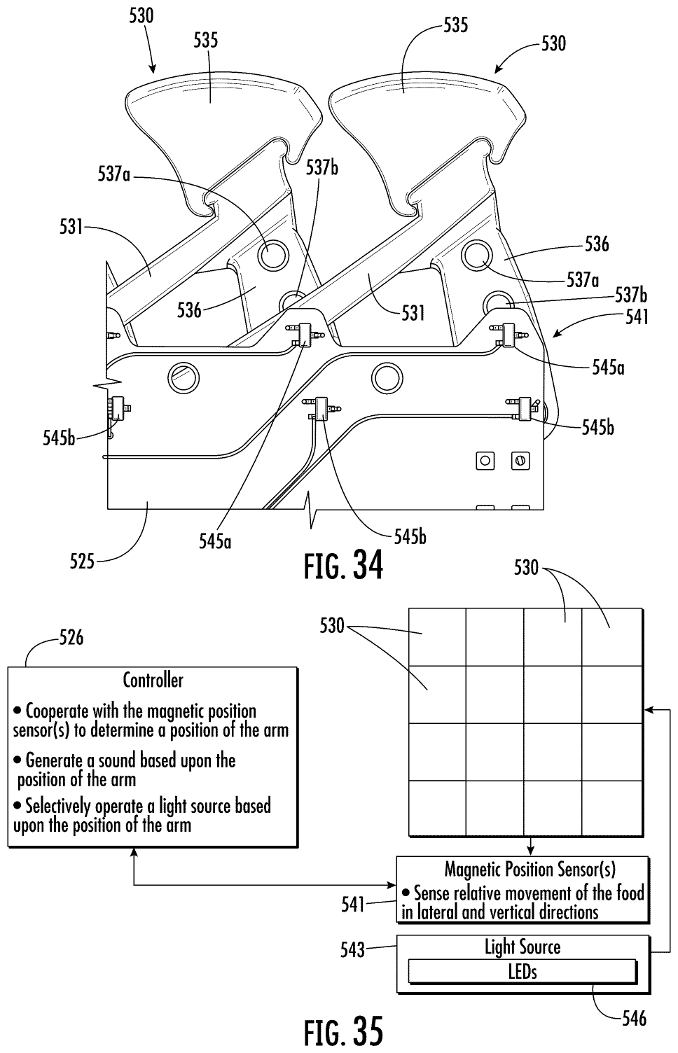

Referring now to FIGS. 31-35 in another embodiment, an electronic music generating device 520 includes key assemblies 530 carried within a housing 501. A display 502 and input devices 503 (e.g., in the form of rotary dial inputs) may also be carried by the housing 501. The key assemblies 530, similar to the embodiments described above, are illustratively arranged in a grid or array of rows and/or columns (FIGS. 31-32). Each key assembly 530, which may be referred to as a key, operates by moving up and down a fixed amount and provides a tactile feel, for example, to a user, like a piano key.

Each key assembly 530 includes a key base 534. Each key assembly 530 also includes an arm 531 having a proximal end pivotably coupled to the key base 534. The arm 531 rotates around a pivot 532. The key base 534 for a row or column of key assemblies 530 may be monolithically formed, for example, molded as a single unit. Multiple bases 534 may be coupled to or carried by a rigid baseplate, for example, as described with respect to the above embodiments.

Each arm 531 may extend over multiple key assembly “lengths” as will be appreciated by those skilled in the art. More particularly, instead of extending over the following key's base 534, a given arm 531 may extend over a larger number of keys 530. The arms 531 may be interleaved in this way to accommodate a combination of achieving longer arms and smaller key sizes, for example.

Each key assembly 530 also illustratively includes a cap 535 carried by a distal end of the arm 531. The cap 535 engages a user's finger to move the arm 531 to a depressed position. Upon disengagement of the user's finger, the arm 531 returns to a unpressed position. The mechanisms for returning the arm 531 to the unpressed position will be described in further detailed below. As described herein, as the cap 535 moves and rotates, the curve of the cap enables the player's finger to maintain a consistent angle of pressure on the key cap, making the movement feel more linear.

Each key assembly 530 also includes a foot 536 coupled to a distal end of the arm 531. The foot 536 extends down to the key base 534 in spaced relation from the proximal end of the arm 531.

A stop member 544 is carried by the key base 534. The stop member 544 engages the foot 535 upon movement of the arm 531 to the depressed position. The stop member 544 may be a resilient material stop member, for example, rubber or a softer plastic relative to a material of the key base 534. The softer or resilient material of the stop member 544 may advantageously provide a softer stop or provide a less rigid stop upon the arm 531, or key 530, being fully depressed.

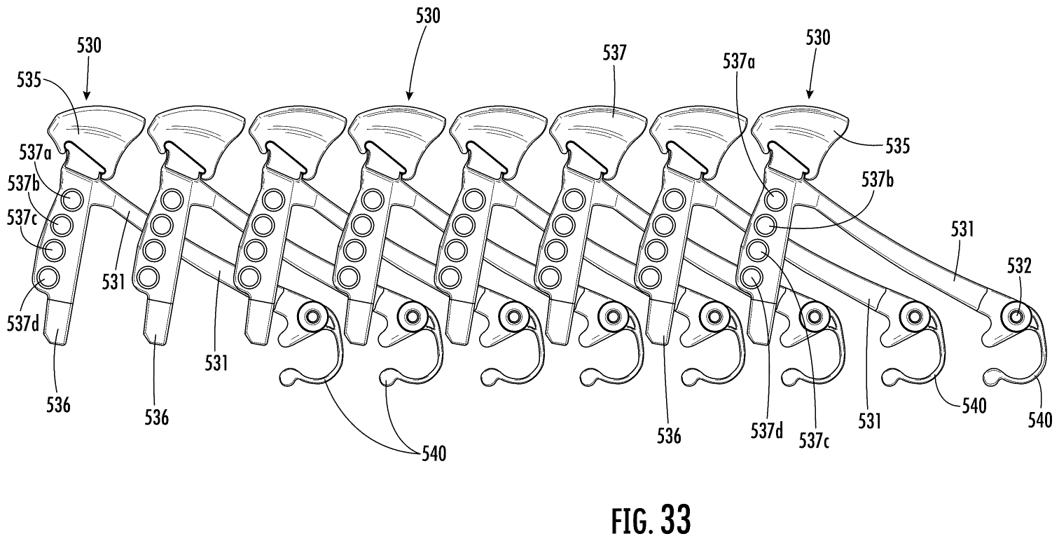

Each key assembly 530 also includes a biasing member 540. The biasing member 540 is illustratively coupled to the arm 531. The biasing member 540 engages the key base 534 for biasing the arm to an unpressed position. The biasing member 540 is illustratively integrally formed with the arm 531 (FIGS. 32-33).

Each key assembly 530 also includes a magnetic position sensor 541 associated with the foot 536. Similar to the embodiments described above, the magnetic position sensor 541, which may be in the form of a first and second Hall sensors 545a, 545b, may be carried by a circuit board or frame 525 adjacent to one or more magnets 537a-537d, as will be described in further detail below. The circuit board 525, which may be a frame rather than a circuit board, runs alongside each key assembly 530. Circuitry, which may be part of a controller 526, may be coupled to the position sensor 541 of each of the key assemblies 530 to determine a position of the foot 536 which also corresponds to the position of the arm 531, and the key cap 535.

The controller 526, based upon the sensed position of the feet 536, generates a sound. More particularly, the controller 526 cooperates with each magnetic position sensor 541 to generates a sound based upon a sensed position of the foot 536. The controller 526 may adjust the generated sounds based upon input the input devices 503, for example, and display, on the display 502, data associated with the generated sound. Of course, other and/or additional data may be displayed, and/or the input devices 503 may operate or control other operations of the electronic music generating device 520. The magnetic position sensor 541 senses relative movement of the foot 536 in lateral and vertical directions, as will be appreciated by those skilled in the art.

Magnets 537a-537d are carried by the foot 536. More particularly, the magnets 537a-537d are recessed along a length of the foot 536. The magnets 537a-537d may be arranged in alternating polarity, for example. The magnets 537a-537d may be aligned with the magnetic position sensor 541, and more particularly, the Hall sensors 545a, 545b. As described with respect to the above-embodiments, the magnets 537a-537d, for example, collectively, may be used not only to detect a position of the foot 536, or key 530, but also to modify a resistance or key force, as will be appreciated by those skilled in the art.

The electronic music generating device 520 may also include a light source 543 coupled to the controller 526. The light source 543 may be coupled to the controller 526 adjacent the key assemblies 530. The controller 526 may selectively operate the light source 543 based upon the position of one or more of the feet 536. The light source 543 may include light emitting diodes (LEDs) 546. Each LED 546 may be associated with a corresponding one of the key assemblies 530. Multiple LEDs 546 may be associated with a given key assembly 530 as described herein. The operation, location, types, and/or colors of the LEDs 546 are similar to those described herein with respect to other embodiments.

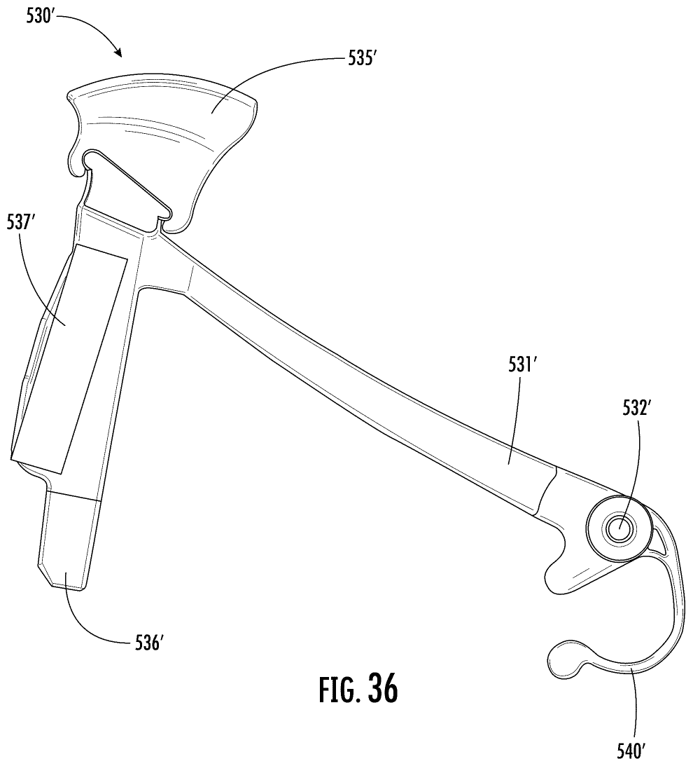

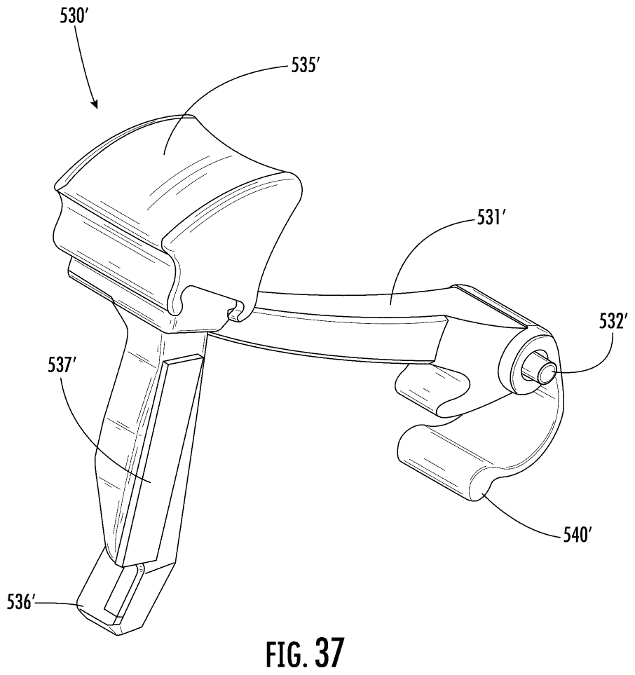

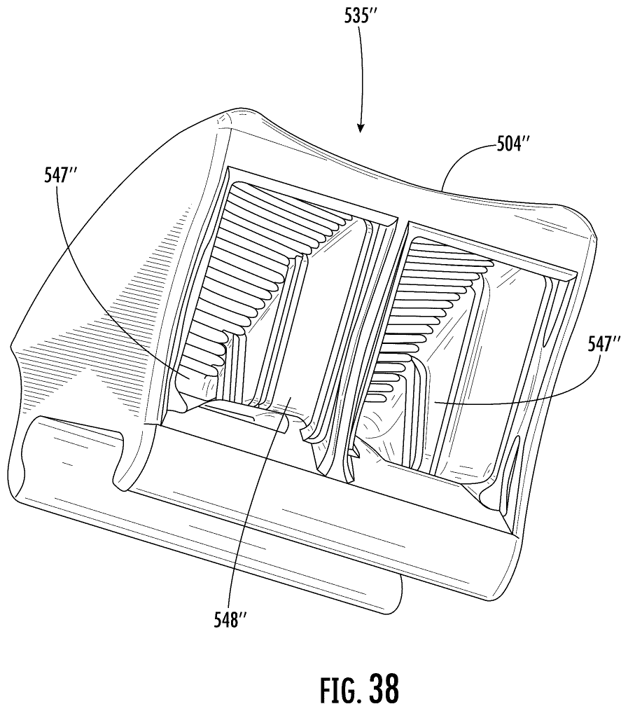

Referring now to FIGS. 36-37, in another embodiment, each key assembly 530′ may include a magnetic tape 537′. The magnetic tape 537′ is carried along a length of the foot 536′. The magnetic tape 537′ may also include alternating poles. Elements illustrated, but not specifically described, such as, the cap 535′, the arm 531′, the biasing member 540′, and the pivot 532′, are similar to those described above.

As will be appreciated by those skilled in the art, the present embodiments combine the benefits of traditional instrument design—including tactile feedback and expressivity with the innovative form factor and user experience of these grid controllers. The present embodiments may also include hardware that allows for the natural motion of a grid of keys, electronics that allow sensing of this motion and tactile feedback, and the software that drives the sound output, user interaction, and feedback.

Referring now briefly to FIG. 38, in accordance with an embodiment, a cap 535″ may have a curved shape, for example, a curved upper surface 504″ for engaging the finger of a user. Additionally, along the lines described above, the cap 535″ illustratively includes a partition 548″, for example, an internal partition. The internal partition 548″ defines individually settable light elements 547″ (e.g., transparent zones) that are placeable adjacent or in alignment with one or more light sources as the cap 535″ may be considered to have an open back. Accordingly, the individually settable light elements 547″ or transparent zones may also be considered a function of the geometry of the cap 535″ being positioned relative to the light sources provided with, for example, just the open back of the cap.

The embodiments, by way of the key assemblies 30 are designed to feel similar to a piano key. Vertical position is sensed in addition to force applied by the user left and right (e.g., horizontal). A controller 26 processes the sensed data from the key assemblies 30, and based thereon, synthesizes sound. The present embodiments may also represent a different paradigm to enable linear motion in a grid, in which a rectangular key cap 35 is attached rigidly to linear rails 371, which move through associated linear guides 372, for example, on a rigid base plate 21. Resistance is provided by a spring 40, for example, metal spring or a compliant mechanism. For example, in any of the embodiments described herein, resistance can be modified nonlinearly with the inclusion of magnets on the mobile and stationary components. Arrangements of these mechanisms allows for either a sharp increase in resistance at the bottom to accommodate aftertouch-specific resistance, or a decrease of resistance at the bottom to assist the user in holding down a pressed note or key assembly.

A method aspect is directed to a method of making a music generating device 520. The method includes assembling each of a plurality of key assemblies 530. Assembling each of the key assemblies 530 includes pivotably coupling a proximal end of an arm 531 to a key base 534, positioning a cap 535 carried by a distal end of the arm for engaging a user's finger to move the arm to a depressed position, and coupling a foot 536 to a distal end of the arm and extending down to the key base in spaced relation from the proximal end of the arm. Assembling each of the key assemblies 530 also includes positioning a stop member 539 carried by the key base 534 to engage the foot 536 upon movement of the arm 531 to a depressed position, coupling a biasing member 540 to the arm to engage the key base for biasing the arm to an unpressed position, and positioning a magnetic position sensor 541 to be associated with each foot 536. The method also includes coupling a controller 526 to cooperate with each magnetic position sensor 541 and configured to generate a sound based upon a sensed position of each foot 536.

Positioning the magnetic position sensor 541 includes positioning a magnetic position sensor configured to sense relative movement of the foot 536 in lateral and vertical directions. Assembling each key assembly 530 includes positioning at least one magnet 537 carried by the foot 536.

The biasing member 540 may be integrally formed with the arm 531. The method also includes arranging the plurality of keys 530 in at least one of rows and columns. The method includes coupling a light source 546 to the controller 526 adjacent the plurality of key assemblies 530. The controller 526 is configured to selectively operate the light source 546 based upon the position of at least one foot 536.

While several embodiments have been described herein, it should be appreciated by those skilled in the art that any element or elements from one or more embodiments may be used with any other element or elements from any other embodiment or embodiments. Moreover, while operation of motors and light sources have been described as in response to a given key, those skilled in the art will appreciate that motors and light sources can be operated responsive to other arms and/or a global state. Still further, while electronic music generating device 20 described herein may be particularly advantageous for generating music, it some embodiments, the elements described herein may be applicable to peripheral devices without music generation and/or for general human-computer interactions.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed. Additionally, while elements have been specifically described, those skilled in the art may appreciate that any combination of elements may be integrally formed, for example, as a monolithic unit. Moreover, any one or more elements from any embodiment may be used with elements of any other embodiment or embodiments.

1. An electronic music generating device comprising:
a plurality of key assemblies, each comprising
a key base,
an arm having a proximal end pivotably coupled to the key base,
a cap carried by a distal end of the arm for engaging a user's finger to move the arm to a depressed position,
a foot coupled to a distal end of the arm and extending down to the key base in spaced relation from the proximal end of the arm,
a stop member carried by the key base and configured to engage the foot upon movement of the arm to a depressed position,
a biasing member coupled to the arm and configured to engage the key base for biasing the arm to an unpressed position, and
a magnetic position sensor associated with the foot; and
a controller cooperating with each magnetic position sensor and configured to generate a sound based upon a sensed position of each foot.

2. The electronic music generating device of claim 1 wherein the magnetic position sensor is configured to sense relative movement of the foot in lateral and vertical directions.

3. The electronic music generating device of claim 1 wherein each key assembly comprises at least one magnet carried by the foot.

4. The electronic music generating device of claim 3 wherein the at least one magnet comprises a plurality of magnets arranged in alternating polarity.

5. The electronic music generating device of claim 3 wherein the at least one magnet comprises magnetic tape.

6. The electronic music generating device of claim 1 wherein the stop member comprises a resilient stop member.

7. The electronic music generating device of claim 1 wherein the biasing member is integrally formed with the arm.

8. The electronic music generating device of claim 1 wherein the plurality of key assemblies is arranged in at least one of rows and columns.

9. The electronic music generating device of claim 1 comprising a light source coupled to the controller adjacent the plurality of key assemblies; and wherein the controller is configured to selectively operate the light source based upon the position of at least one foot.

10. The electronic music generating device of claim 9 wherein the light source comprises a plurality of light emitting diodes each associated with a corresponding one of the plurality of key assemblies.

11. The electronic music generating device of claim 1 comprising a haptic actuator coupled to the controller to provide haptic feedback based upon the sensed position of each foot.

12. The electronic music generating device of claim 1 wherein the cap has a curved shape.

13. The electronic music generating device of claim 1 wherein the cap has at least one internal partition to define a plurality of individually settable light elements.

14. An electronic music generating device comprising:
a plurality of key assemblies, each comprising
a key base,
an arm having a proximal end pivotably coupled to the key base,
a cap carried by a distal end of the arm for engaging a user's finger to move the arm to a depressed position,
a foot coupled to a distal end of the arm and extending down to the key base in spaced relation from the proximal end of the arm,
a stop member carried by the key base and configured to engage the foot upon movement of the arm to a depressed position,
a biasing member integrally formed with the arm and configured to engage the key base for biasing the arm to an unpressed position,
at least one magnet carried by the foot, and
a magnetic position sensor associated with the foot; and
a controller cooperating with each magnetic position sensor and configured to generate a sound based upon a sensed position of each foot.

15. The electronic music generating device of claim 14 wherein the magnetic position sensor is configured to sense relative movement of the foot in lateral and vertical directions.

16. The electronic music generating device of claim 14 wherein the at least one magnet comprises a plurality of magnets arranged in alternating polarity.

17. The electronic music generating device of claim 14 wherein the at least one magnet comprises magnetic tape.

18. The electronic music generating device of claim 14 wherein the stop member comprises a resilient stop member.

19. The electronic music generating device of claim 14 wherein the plurality of key assemblies is arranged in at least one of rows and columns.

20. The electronic music generating device of claim 14 comprising a light source coupled to the controller adjacent the plurality of key assemblies; and wherein the controller is configured to selectively operate the light source based upon the position of at least one foot.

21. The electronic music generating device of claim 14 comprising a haptic actuator coupled to the controller to provide haptic feedback based upon the sensed position of each foot.

22. The electronic music generating device of claim 14 wherein the cap has at least one internal partition to define a plurality of individually settable light elements.

23. A method of making an electronic music playing device comprising:
assembling each of a plurality of key assemblies, comprising
pivotably coupling a proximal end of an arm to a key base,
positioning a cap carried by a distal end of the arm for engaging a user's finger to move the arm to a depressed position,
coupling a foot to a distal end of the arm and extending down to the key base in spaced relation from the proximal end of the arm,
positioning a stop member carried by the key base to engage the foot upon movement of the arm to a depressed position,
coupling a biasing member to the arm to engage the key base for biasing the arm to an unpressed position, and
positioning a magnetic position sensor to be associated with the foot; and
coupling a controller to cooperate with each magnetic position sensor and configured to generate a sound based upon a sensed position of each foot.

24. The method of claim 23 wherein positioning the magnetic position sensor comprising positioning a magnetic position sensor to sense relative movement of the foot in lateral and vertical directions.

25. The method of claim 23 wherein assembling each key assembly comprises positioning at least one magnet carried by the foot.

26. The method of claim 18 wherein the biasing member is integrally formed with the arm.

27. The method of claim 23 comprising arranging the plurality of key assemblies in at least one of rows and columns.

28. The method of claim 23 comprising coupling a light source to the controller adjacent the plurality of key assemblies; and wherein the controller is configured to selectively operate the light source based upon the position of at least one foot.

29. The method of claim 23 comprising coupling a haptic actuator to the controller to provide haptic feedback based upon the sensed position of each foot.
